(19) United States
(12) Patent Application Publication
(10) Pub. No.: US 2026/0220315 A1
(43) Pub. Date: Jul. 30, 2026

(54) METHOD AND SYSTEM OF ASSEMBLING GEOMETRIC COMPONENTS IN A COMPUTER-AIDED DESIGN ENVIRONMENT

(71) Applicant: Siemens Industry Software Inc., Plano, TX (US)

(72) Inventor: Avijit Sen, Pune (IN)

(21) Appl. No.: 19/144,697

(22) PCT Filed: Apr. 27, 2023
(86) PCT No.: PCT/US2023/020185

§ 371 Date: Jun. 30, 2025

(30) Foreign Application Priority Data
Jan. 20, 2023 (IN) 202331004028

(51) Int. Cl. G06F 30/10; G06F 111/04

(52) U.S. Cl. CPC G06F 30/10; G06F 2111/04

(57) ABSTRACT

A method and system for assembling one or more geometric components in a computer-aided design (CAD) environment is disclosed. In one embodiment, a method includes generating a first set of points corresponding to geometric feature(s) of a first geometric component and generating a second set of points corresponding to geometric feature(s) of a second geometric component. The method further includes determining whether there is a match between the first set of points and the second set of points based on distances between the first set of points and distances between the second set of points. Furthermore, the method includes generating assembly solution(s) for assembling the first geometric component and the second geometric component based on the match between the first set of points and the second set of points. Moreover, the method includes generating a CAD model including the first geometric component constrained with the second geometric component.

The present patent document is a § 371 nationalization of PCT Application Serial No. PCT/US2023/020185, filed Apr. 27, 2023, designating the United States, and this patent document also claims the benefit of Indian Patent Application No. 202331004028, filed Jan. 20, 2023, which are hereby incorporated by reference in their entireties.

### FIELD OF TECHNOLOGY

The present disclosure relates to the field of computer-aided design, and more particularly to a method and system of assembling geometric components in a computer-aided design environment.

### BACKGROUND

In a computer-aided design (CAD), a designer creates a geometric assembly by designing geometric components and position each component with respect to one or more geometric components in a computer-aided design environment. For example, a designer builds an engine assembly by positioning an oil sump with respect to an engine block. Currently known CAD tools require to manually position the geometric component with other geometric component(s) to build a geometric assembly. For example, the designer needs to drag and drop the face of the geometric component onto the face of the other geometric component in the CAD environment to assembly the two geometric components, which is a cumbersome, time consuming, and erroneous activity.

### SUMMARY

The scope of the present disclosure is defined solely by the appended claims and is not affected to any degree by the statements within this summary. The present embodiments may obviate one or more of the drawbacks or limitations in the related art.

A method and system of assembling geometric components in a computer-aided design (CAD) environment is disclosed. In one aspect, a method of assembling one or more geometric components in a CAD environment includes generating a first set of points corresponding to at least one geometric feature of the first geometric component and generating a second set of points corresponding to at least one geometric feature of the second geometric component. The method further includes determining whether there is a match between the first set of points corresponding to at least one geometric feature of the first geometric component and the second set of points corresponding to the least one geometric feature of the second geometric component based on distances between the first set of points and distances between the second set of points. Furthermore, the method includes generating one or more assembly solutions for assembling the first geometric component and the second geometric component based on the match between the first set of points and the second set of points if there is a match between the first set of points and the second set of points.

Also, the method may include ranking the assembly solutions for assembling the first geometric component and the second geometric component. Additionally, the method may include positioning the first geometric component with respect to the second geometric component in a CAD environment based on the at least one assembly solution in the CAD environment and generating a CAD model including the first geometric component constrained with the second geometric component.

Moreover, the method may include computing the distances between the first set of points corresponding to the at least one geometric feature of the first geometric component. For example, the first set of points correspond to a plane in the first geometric component. The method may further include computing the distances between the second set of points corresponding to the at least one geometric feature of the second geometric component. For example, the second set of points correspond to a plane in the second geometric component. The method may include generating a first map between value of distances and the first set of points and a second map between value of distances and the second set of points. In some embodiments, the method may include generating a first graphical representation based on the first set of points and the value of associated distances and generating a second graphical representation based on the second set of points and value of the associated distances. The method may include generating the first map between the value of distances and the first set of points and the second map between the value of distances and the second set of points.

In determining whether there is a match between the first set of points and the second set of points, the method includes determining whether there is a match between the value of distances in the first map and the value of distances in the second map.

In generating one or more assembly solutions for assembling the first geometric component and the second geometric component, the method may include determining one to one correspondence between the first set of points and the second set of points, and computing a three-dimensional transformation matrix based on the one to one correspondence between the first set of points and the second set of points, and generating the one or more assembly solutions for assembling the first geometric component and the second geometric component based on the three-dimensional transformation matrix.

In another aspect, a data processing system includes a processor, and an accessible memory communicatively coupled to the processor. The memory unit includes a CAD assembly module configured to generate a first set of points corresponding to at least one geometric feature of the first geometric component, generate a second set of points corresponding to at least one geometric feature of the second geometric component, determine whether there is a match between the first set of points corresponding to at least one geometric feature of the first geometric component and the second set of points corresponding to the least one geometric feature of the second geometric component based on distances between the first set of points and distances between the second set of points, and generate one or more assembly solutions for assembling the first geometric component and the second geometric component based on the match between the first set of points and the second set of points.

The CAD assembly module is configured to rank the assembly solutions for assembling the first geometric component and the second geometric component. The CAD assembly module is configured to position the first geometric component with respect to the second geometric component in a CAD environment based on the at least one assembly solution in the CAD environment and generate a CAD model including the first geometric component constrained with the second geometric component.

The CAD assembly module is configured to: compute the distances between the first set of points corresponding to the at least one geometric feature of the first geometric component, wherein the first set of points correspond to a plane in the first geometric component; compute the distances between the second set of points corresponding to the at least one geometric feature of the second geometric component, wherein the second set of points correspond to a plane in the second geometric component; and generate a first map between value of distances and the first set of points and a second map between value of distances and the second set of points.

In generating the first map and the second map, the CAD assembly module is configured to generate a first graphical representation based on the first set of points and the value of associated distances and generate a second graphical representation based on the second set of points and value of the associated distances, and generate the first map between the value of distances and the first set of points and the second map between the value of distances and the second set of points.

In determining whether there is a match between the first set of points and the second set of points, the CAD assembly is configured to determine whether there is a match between the value of distances in the first map and the value of distances in the second map.

In generating one or more assembly solutions for assembling the first geometric component and the second geometric component, the CAD assembly module is configured to determine one to one correspondence between the first set of points and the second set of points, compute a three-dimensional transformation matrix based on the one to one correspondence between the first set of points and the second set of points, and generate the one or more assembly solutions for assembling the first geometric component and the second geometric component based on the three-dimensional transformation matrix.

In yet another aspect, a non-transitory computer-readable storage medium, having machine-readable instructions stored therein, which when executed by a data processing system, cause the data processing system to perform the method described above.

This summary is provided to introduce a selection of concepts in a simplified form that are further described below in the following description. It is not intended to identify features or essential features of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of an exemplary data processing system for assembling geometric components in a computer-aided design (CAD) environment, according to one embodiment.

FIG. 2 is a schematic representation of a data processing system capable of assembling geometric components in a CAD environment, according to another embodiment.

FIG. 3 illustrates a block diagram of a data processing system capable of assembling geometric components in a CAD environment, according to yet another embodiment.

FIG. 4 is a process flowchart of an exemplary method of assembling one or more geometric components in a computer-aided design environment, according to one embodiment.

FIG. 5 is a process flowchart depicting an exemplary method of generating one or more assembly solutions for assembling a first geometric component and a second geometric component, according to one embodiment.

### DETAILED DESCRIPTION

A method and system of assembling geometric components in a computer-aided design (CAD) environment is disclosed. Various embodiments are described with reference to the drawings, where like reference numerals are used in reference to the drawings. Like reference numerals are used to refer to like elements throughout. In the following description, numerous specific details are set forth in order to provide a thorough understanding of embodiments. These specific details need not be employed to practice embodiments. In other instances, well known materials or methods have not been described in detail in order to avoid unnecessarily obscuring embodiments. While the disclosure is susceptible to various modifications and alternative forms, specific embodiments thereof are shown by way of example in the drawings and are herein described in detail. There is no intent to limit the disclosure to the particular forms disclosed. Instead, the disclosure is to cover all modifications, equivalents, and alternatives falling within the spirit and scope of the present disclosure.

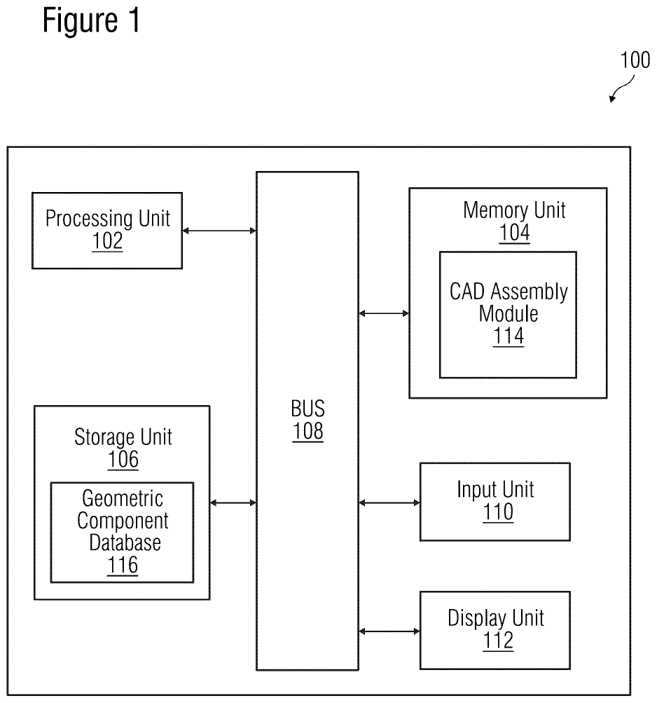

FIG. 1 is a block diagram of an exemplary data processing system 100 for assembling geometric components in a computer-aided design (CAD) environment, according to one embodiment. The data processing system 100 may be a personal computer, workstation, laptop computer, tablet computer, and the like. In FIG. 1, the data processing system 100 includes a processor 102, a memory 104, a storage unit 106, a bus 108, an input unit 110, and a display unit 112. The data processing system 100 is a specific purpose computer configured to assemble geometric components in the CAD environment.

The processor 102, as used herein, means any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processor 102 may also include embedded controllers, such as generic or programmable logic devices or arrays, application specific integrated circuits, single-chip computers, and the like.

The memory 104 may be non-transitory volatile memory and non-volatile memory. The memory 104 may be coupled for communication with the processor 102, such as being a computer-readable storage medium. The processor 102 may execute instructions and/or code stored in the memory 104. A variety of computer-readable instructions may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

In the present embodiment, the memory 104 includes a component generation module 114 stored in the form of machine-readable instructions on any of the above-mentioned storage media and may be in communication to and executed by the processor 102. When the machine-readable instructions are executed by the processor 102, the CAD assembly module 114 causes the processor 102 to generate a first set of points corresponding to at least one geometric feature of a first geometric component, generate a second set of points corresponding to at least one geometric feature of the second geometric component, determine whether there is a match between the first set of points and the second set of points based on distances between the first set of points and distances between the second set of points, and generate one or more assembly solutions for assembling the first geometric component and the second geometric component if there is a match between the first set of points and the second set of points.

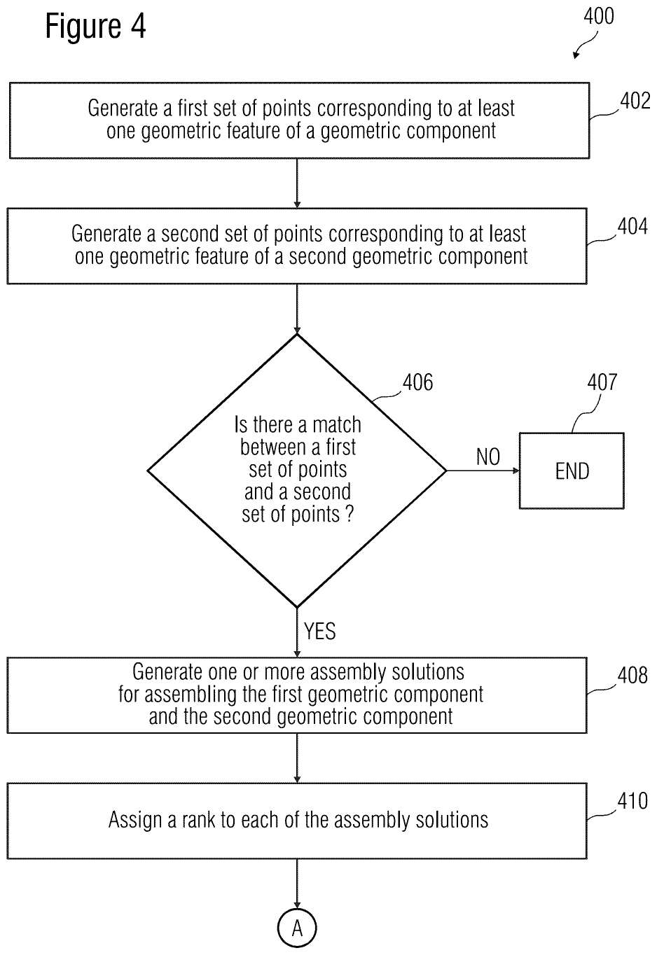

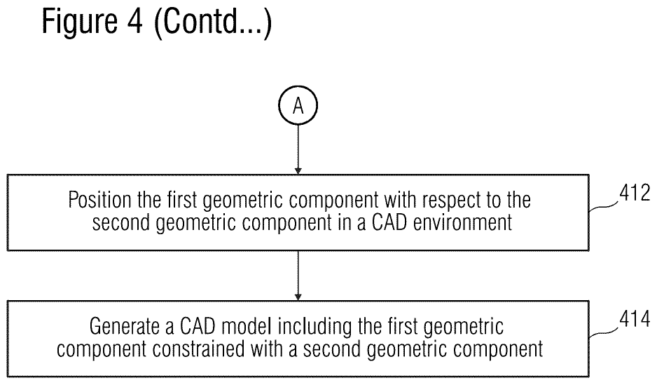

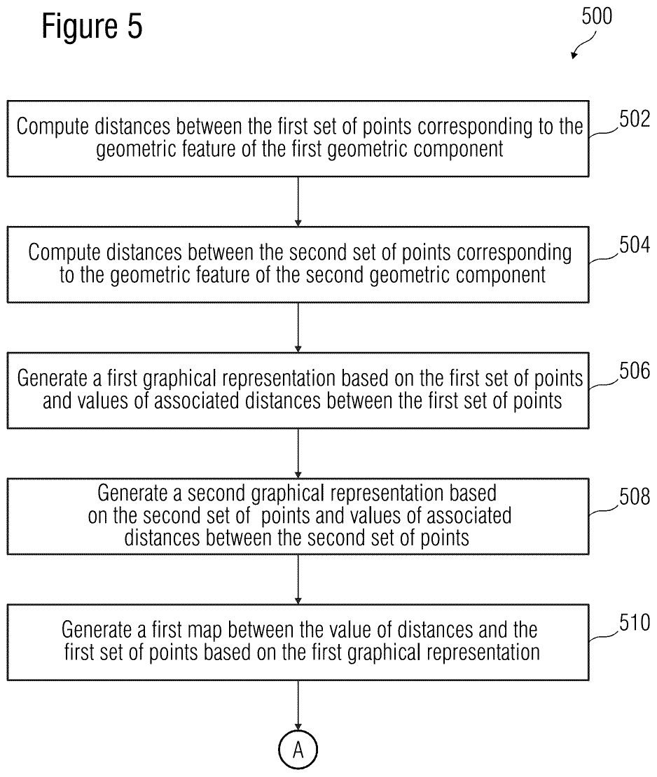

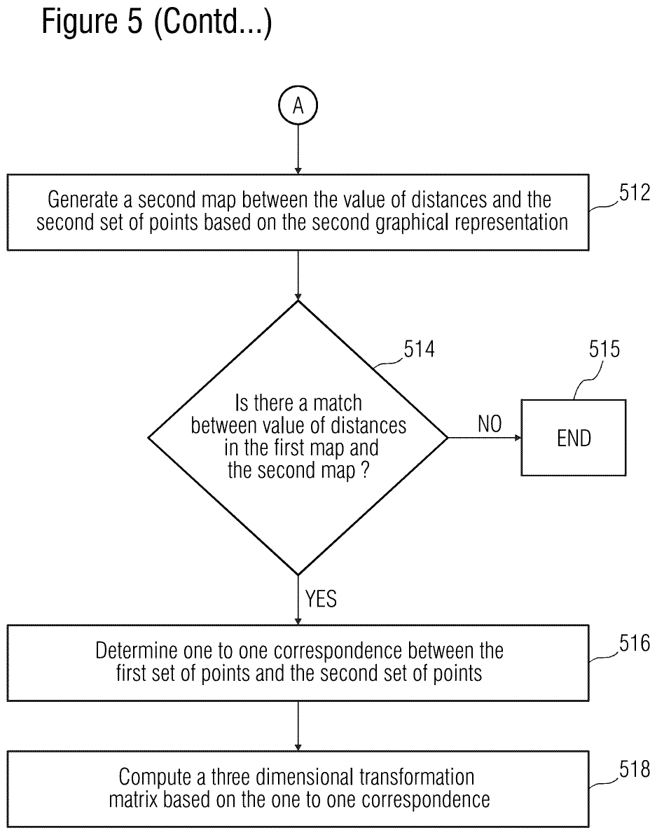

Additionally, when the machine-readable instructions are executed by the processor 102, the CAD assembly module 114 may cause the processor 102 to rank the assembly solutions for assembling the first geometric component and the second geometric component, position the first geometric component with respect to the second geometric component in a CAD environment based on the at least one assembly solution in the CAD environment, and generate a CAD model including the first geometric component constrained with the second geometric component. Method acts performed by the processor 102 to achieve the above functionality are described in greater detail in FIG. 4 and FIG. 5.

The storage unit 106 may be a non-transitory storage medium which stores a geometric component database 116. The geometric component database 116 stores geometric feature information associated with geometric components. The input unit 110 may include input devices such as keypad, touch-sensitive display, camera (such as a camera receiving gesture-based inputs), etc. capable of receiving input signals such as a CAD command for assembling geometric components in the CAD environment. The display unit 112 may be a device with a graphical user interface displaying a multi-dimensional visual representation of the assembled geometric components. The graphical user interface may also enable users to select a CAD command for performing assembly operation on the geometric components. The bus 108 acts as interconnect between the processor 102, the memory 104, the storage unit 106, the input unit 110, and the display unit 112.

Those of ordinary skilled in the art will appreciate that the hardware depicted in FIG. 1 may vary for particular implementations. For example, other peripheral devices such as an optical disk drive and the like, Local Area Network (LAN)/ Wide Area Network (WAN)/ Wireless (e.g., Wi-Fi) adapter, graphics adapter, disk controller, input/output (I/O) adapter also may be used in addition to or in place of the hardware depicted. The depicted example is provided for the purpose of explanation only and is not meant to imply architectural limitations with respect to the present disclosure.

The data processing system 100 in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and/or an event such as clicking a mouse button, generated to actuate a desired response.

One of various commercial operating systems, such as a version of Microsoft Windows™, a product of Microsoft Corporation located in Redmond, Washington may be employed if suitably modified. The operating system is modified or created in accordance with the present disclosure as described.

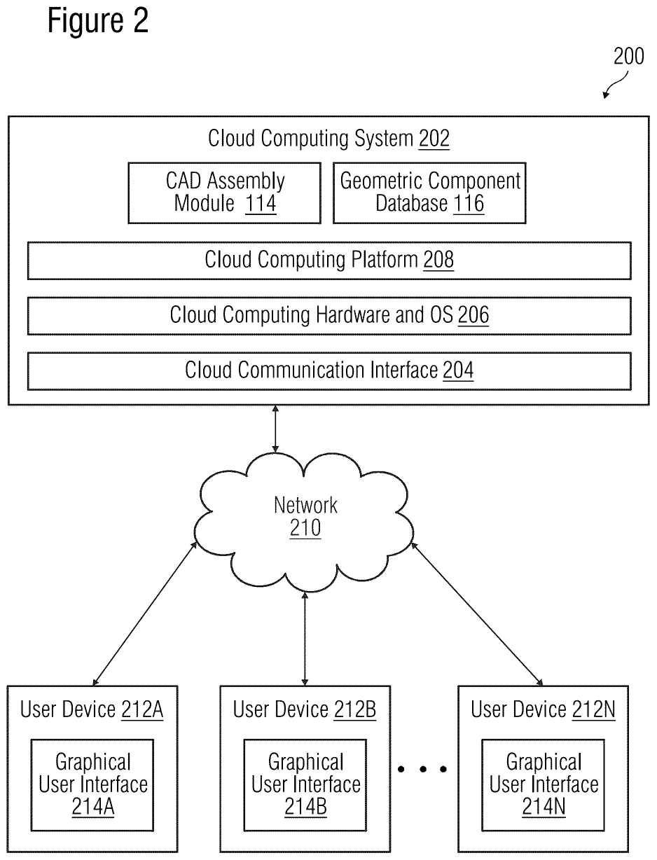

FIG. 2 is a schematic representation of a data processing system 200 capable of assembling geometric components in a CAD environment, according to another embodiment. Particularly, the data processing system 200 includes a cloud computing system 202 configured for providing cloud services for assembling geometric components in a CAD environment.

The cloud computing system 202 includes a cloud communication interface 206, cloud computing hardware and OS 208, a cloud computing platform 210, the CAD assembly module 114, and the geometric database 116. The cloud communication interface 206 enables communication between the cloud computing platform 210, and user devices 212A-N such as smart phone, tablet, computer, etc. via a network 204.

The cloud computing hardware and OS 208 may include one or more servers on which an operating system (OS) is installed and includes one or more processors, one or more storage devices for storing data, and other peripherals required for providing cloud computing functionality. The cloud computing platform 210 is a platform which implements functionalities such as data storage, data analysis, data visualization, data communication on the cloud hardware and OS 208 via application programming interfaces (APIs) and algorithm; and delivers the aforementioned cloud services using cloud-based applications (e.g., application for assembling geometric components). The cloud computing platform 210 employs the CAD assembly module 114 for automatically assembling geometric components as described in FIG. 1. The cloud computing platform 210 also includes the geometric database 116.

The user devices 212A-N include graphical user interfaces 214A-N for assembling geometric components in a CAD environment. Each of the user devices 212A-N may be provided with a communication interface for interfacing with the cloud computing system 202. Users (e.g., design engineer) of the user devices 212A-N may access the cloud computing system 202 via the graphical user interfaces 214A-N. The graphical user interfaces 214A-N may be specifically designed for accessing the CAD assembly module 114 in the cloud computing system 202.

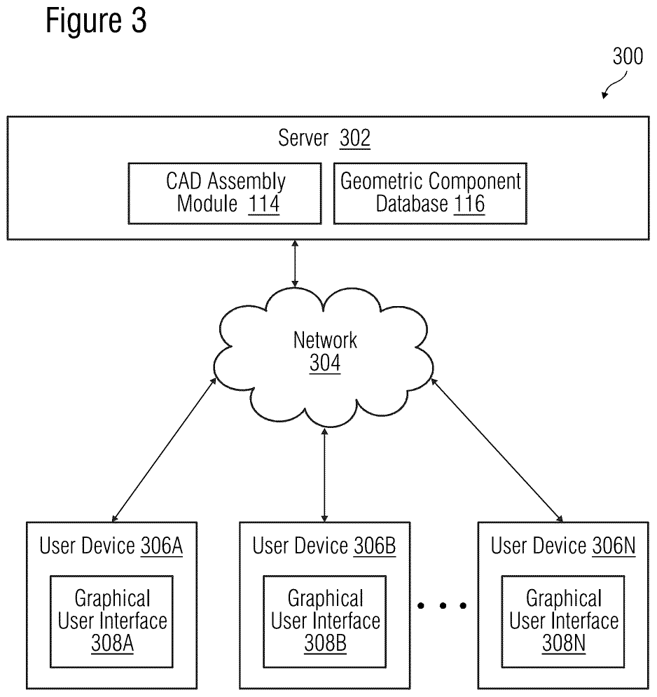

FIG. 3 illustrates a block diagram of a data processing system 300 capable of assembling geometric components in a CAD environment, according to yet another embodiment. Particularly, the data processing system 300 includes a server 302 and a plurality of user devices 306A-N. Each of the user devices 306A-N is connected to the server 302 via a network 304 (e.g., Local Area Network (LAN), Wide Area Network (WAN), Wi-Fi, etc.). The system 300 is another implementation of the data processing system 100 of FIG. 1, where the CAD assembly module 114 resides in the server 302 and is accessed by user devices 306A-N via the network 304.

The server 302 includes the CAD assembly module 114, and the geometric database 116. The server 302 may also include a processor, a memory unit, and a storage unit. The CAD assembly module 114 may be stored on the memory unit in the form of machine-readable instructions and executable by the processor. The geometric database 116 may be stored in the storage unit. The server 302 may also include a communication interface for enabling communication with user devices 306A-N via the network 304.

FIG. 4 is a process flowchart 400 of an exemplary method of assembling one or more geometric components in a computer-aided design environment, according to one embodiment.

At act 402, a first set of points corresponding to at least one geometric feature of a first geometric component is generated. In one embodiment, the first set of points correspond to a plane in the first geometric component.

At act 404, a second set of points corresponding to at least one geometric feature of a second geometric component is generated. In one embodiment, the second set of points correspond to a plane in the second geometric component. The first set of points and the second set of points are generated from specific geometric features of the first geometric component and the second geometric component. For example, the specific geometric features may be holes on respective planes of the first geometric component (e.g., an engine block) and the second geometric component (e.g., an oil sump).

At act 406, it is determined whether there is a match between the first set of points corresponding to at least one geometric feature of the first geometric component and the second set of points corresponding to the least one geometric feature of the second geometric component.

At act 408, one or more assembly solutions for assembling the first geometric component and the second geometric component are generated if there is a match between the first set of points and the second set of points, else the process 400 is terminated at act 407.

At act 410, a rank is assigned to each of the assembly solutions for assembling the first geometric component and the second geometric component.

At act 412, the first geometric component is positioned with respect to the second geometric component in a CAD environment based on the best matching assembly solution in the CAD environment. In some embodiments, the best matching assembly solution is identified based on the rank assigned to the assembly solution.

At act 414, a CAD model including the first geometric component constrained with the second geometric component is generated.

FIG. 5 is a process flowchart 500 depicting an exemplary method of generating one or more assembly solutions for assembling a first geometric component and a second geometric component, according to one embodiment.

At act 502, distances between the first set of points corresponding to the geometric feature of the first geometric component are computed.

At act 504, distances between the second set of points corresponding to the geometric feature of the second geometric component are computed. For example, coordinate of center of holes lying in a same plane is obtained from the first component (e.g., engine block) and the second component (e.g., oil sump).

At act 506, a first graphical representation is generated based on the first set of points and the value of associated distances between the first set of points corresponding to the geometric feature of the first geometric component.

At act 508, a second graphical representation is generated based on the second set of points and value of the associated distances. For example, a graphical representation is formed from the holes in the given plane. The center is a node and distances are edges of the graph.

At act 510, a first map between the value of distances and the first set of points is generated based on the first graphical representation. For example, the first map is created between a value of distance between the holes and associated center pairs of the holes of the engine block.

At act 512, a second map between the value of distances and the second set of points based on the second graphical representation. For example, the second map is created between a value of distance between the holes and associated center pairs of the holes of the oil sump.

At act 514, it is determined whether there is a match between the value of distances in the first map and the value of distances in the second map. In one exemplary implementation, it is determined whether the distances in the map associated with the plane in the engine block matches with the distances in the map associated with one or more planes in the oil sump.

At act 516, one-to-one correspondence between the first set of points and the second set of points is determined if there is a match between the value of distances in the first map and the value of distances in the second map. For example, matching distance between the holes in the plane of the first geometric component and the plane of the second geometric component is found using the first map and the second map. Also, associated point pairs are traversed from the first graph and the second graph. Accordingly, other connected points which have same corresponding distances are identified from the first graph and the second graph. If it is no match is found, then process 500 is terminated at act 515.

At act 518, a three-dimensional transformation matrix is computed based on the one-to-one correspondence between the first set of points and the second set of points. For example, the three-dimensional transformation matrix enables the first geometric component geometrically overlaps with the second geometric component(s) in such a manner that the first set of points and the second set of points found to be having one-to-one correspondence coincide geometrically.

One or more assembly solutions for assembling the first geometric component and the second geometric component may be generated based on the three-dimensional transformation matrix. In such a case, the one or more assembly solutions for assembling the first geometric component and the second geometric component is ranked.

The system and methods described herein may be implemented in various forms of hardware, software, firmware, special purpose processors, or a combination thereof. One or more of the present embodiments may take a form of a computer program product including program modules accessible from computer-usable or computer-readable medium storing program code for use by or in connection with one or more computers, processors, or instruction execution system.

For the purpose of this description, a computer-usable or computer-readable medium may be any apparatus that may contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation mediums in and of themselves as signal carriers are not included in the definition of physical computer-readable medium including a semiconductor or solid state memory, magnetic tape, a removable computer diskette, random access memory (RAM), a read only memory (ROM), a rigid magnetic disk, optical disk such as compact disk read-only memory (CD-ROM), compact disk read/write, and digital versatile disc (DVD) or any combination thereof. Both processors and program code for implementing each aspect of the technology may be centralized or distributed (or a combination thereof) as known to those skilled in the art.

While the present disclosure has been described in detail with reference to certain embodiments, the present disclosure is not limited to those embodiments. In view of the present disclosure, many modifications and variations would present themselves, to those skilled in the art without departing from the scope of the various embodiments of the present disclosure, as described herein.

1. A method of assembling one or more geometric components in a computer-aided design (CAD) environment, the method comprising:
generating a first set of points corresponding to at least one geometric feature of a first geometric component;
generating a second set of points corresponding to at least one geometric feature of a second geometric component;
identifying a match between the first set of points corresponding to the at least one geometric feature of the first geometric component and the second set of points corresponding to the least one geometric feature of the second geometric component based on distances between the first set of points and distances between the second set of points; and
generating at least one assembly solution for assembling the first geometric component and the second geometric component based on the match between the first set of points and the second set of points.

2. The method of claim 1, further comprising:
positioning the first geometric component with respect to the second geometric component in the CAD environment based on the at least one assembly solution in the CAD environment; and
generating a CAD model comprising the first geometric component constrained with the second geometric component.

3. The method of claim 1, further comprising:
computing the distances between the first set of points corresponding to the at least one geometric feature of the first geometric component, wherein the first set of points correspond to a plane in the first geometric component;
computing the distances between the second set of points corresponding to the at least one geometric feature of the second geometric component, wherein the second set of points correspond to a plane in the second geometric component; and
generating a first map between a value of distances and the first set of points and a second map between a value of distances and the second set of points.

4. The method of claim 3, wherein the generating of the first map comprises:
generating a first graphical representation based on the first set of points and the value of associated distances, and a second graphical representation based on the second set of points and the value of associated distances; and
generating the first map between the value of distances and the first set of points and the second map between the value of distances and the second set of points.

5. The method of claim 4, wherein the identifying of the match between comprises:
determining the match between the value of distances in the first map and the value of distances in the second map.

6. The method of claim 1, further comprising:
ranking assembly solutions of the at least one assembly solution for assembling the first geometric component and the second geometric component.

7. The method of claim 1, wherein the generating of the at least one assembly solution comprises:
determining one to one correspondence between the first set of points and the second set of points;
computing a three-dimensional transformation matrix based on the one to one correspondence between the first set of points and the second set of points; and
generating the at least one assembly solution for assembling the first geometric component and the second geometric component based on the three-dimensional transformation matrix.

8. A data processing system comprising:
a processor;
an accessible memory communicatively coupled to the processor, wherein the processor and memory are configured to:
generate a first set of points corresponding to at least one geometric feature of a first geometric component;
generate a second set of points corresponding to at least one geometric feature of a second geometric component;
identify a match between the first set of points corresponding to at least one geometric feature of the first geometric component and the second set of points corresponding to the least one geometric feature of the second geometric component based on distances between the first set of points and distances between the second set of points; and
generate at least one assembly solution for assembling the first geometric component and the second geometric component based on the match between the first set of points and the second set of points.

9. The data processing system of claim 8, wherein the processor and the memory are further configured to:
position the first geometric component with respect to the second geometric component in a computer-aided design (CAD) environment based on the at least one assembly solution in the CAD environment; and
generate a CAD model comprising the first geometric component constrained with the second geometric component.

10. The data processing system of claim 8, wherein the processor and the memory are further configured to:
compute the distances between the first set of points corresponding to the at least one geometric feature of the first geometric component, wherein the first set of points correspond to a plane in the first geometric component;
compute the distances between the second set of points corresponding to the at least one geometric feature of the second geometric component, wherein the second set of points correspond to a plane in the second geometric component; and
generate a first map between a value of distances and the first set of points and a second map between a value of distances and the second set of points.

11. The data processing system of claim 10, wherein, in the generating of the first map, the processor and the memory are configured to:
generate a first graphical representation based on the first set of points and the value of associated distances, and a second graphical representation based on the second set of points and the value of associated distances; and
generate the first map between the value of distances and the first set of points and the second map between the value of distances and the second set of points.

12. The data processing system of claim 11, wherein, in the identifying of the match, the processor and the memory are configured to:
determine the match between the value of distances in the first map and the value of distances in the second map.

13. The data processing system of claim 8, wherein the processor and the memory are further configured to:
rank assembly solutions of the at least one assembly solution for assembling the first geometric component and the second geometric component.

14. The data processing system of claim 8, wherein, in the generating of the at least one assembly solution, the processor and the memory are configured to:
determine one to one correspondence between the first set of points and the second set of points;
compute a three-dimensional transformation matrix based on the one to one correspondence between the first set of points and the second set of points; and
generate the at least one assembly solution for assembling the first geometric component and the second geometric component based on the three-dimensional transformation matrix.

15. A non-transitory computer-readable storage medium, having machine-readable instructions stored therein, which, when executed by a data processing system, cause the data processing system to:
generate a first set of points corresponding to at least one geometric feature of a first geometric component;
generate a second set of points corresponding to at least one geometric feature of a second geometric component;
identify a match between the first set of points corresponding to at least one geometric feature of the first geometric component and the second set of points corresponding to the least one geometric feature of the second geometric component based on distances between the first set of points and distances between the second set of points; and
generate at least one assembly solution for assembling the first geometric component and the second geometric component based on the match between the first set of points and the second set of points.

16. The non-transitory computer-readable storage medium of claim 15, wherein the machine-readable instructions cause the data processing system to:
position the first geometric component with respect to the second geometric component in a computer-aided design (CAD) environment based on the at least one assembly solution in the CAD environment; and
generate a CAD model comprising the first geometric component constrained with the second geometric component.

17. The non-transitory computer-readable storage medium of claim 15, wherein the machine-readable instructions cause the data processing system to:
compute the distances between the first set of points corresponding to the at least one geometric feature of the first geometric component, wherein the first set of points correspond to a plane in the first geometric component;
compute the distances between the second set of points corresponding to the at least one geometric feature of the second geometric component, wherein the second set of points correspond to a plane in the second geometric component; and
generate a first map between value of distances and the first set of points and a second map between value of distances and the second set of points.

18. The non-transitory computer-readable storage medium of claim 17, wherein the machine-readable instructions cause the data processing system to:
generate a first graphical representation based on the first set of points and the value of associated distances, and a second graphical representation based on the second set of points and the value of associated distances; and
generate the first map between the value of distances and the first set of points and the second map between the value of distances and the second set of points.

19. The non-transitory computer-readable storage medium of claim 18, wherein the machine-readable instructions cause the data processing system to:
determine the match between the value of distances in the first map and the value of distances in the second map.

20. The non-transitory computer-readable storage medium of claim 15, wherein the machine-readable instructions cause the data processing system to:
determine one to one correspondence between the first set of points and the second set of points; and
compute a three-dimensional transformation matrix based on the one to one correspondence between the first set of points and the second set of points; and
generate the at least one assembly solution for assembling the first geometric component and the second geometric component based on the three-dimensional transformation matrix.
